(19) United States
(12) Patent Application Publication
(10) Pub. No.: US 2012/0030725 A1
(43) Pub. Date: Feb. 2, 2012

(54) CONTENTS URL NOTIFICATION SYSTEM

(76) Inventor: Hachirou SENO, Fukuoka (JP)

(21) Appl. No.: 13/267,177

(22) Filed: Oct. 6, 2011

Related U.S. Application Data
(63) Continuation of application No. PCT/JP2010/056519, filed on Apr. 12, 2010.

(30) Foreign Application Priority Data
Apr. 13, 2009 (JP) 2009-097235

(51) Int. Cl. H04N 21/858

(52) U.S. Cl. 725/113

(57) ABSTRACT

A contents URL notification system is configured to notify users of contents URLs using TV sets. In the contents URL notification system, a server computer of a content provider transmits information related to the contents URL (URL information) to a client computer via an electronic communication network. The client computer prepares TV data for broadcasting the URL information received from the server computer. A terminal device of the user accesses the server computer via the electronic communication network according to the URL information extracted from the TV data thus prepared with the client computer.

### CROSS-REFERENCE TO RELATED APPLICATIONS

This is a continuation application of the prior PCT application PCT/JP2010/56519, filed on Apr. 12, 2010, pending, which claims priority from a Japanese patent application No. 2009-097235, filed on Apr. 13, 2009, the entire content of which is incorporated herein by reference.

### BACKGROUND OF THE PRESENT INVENTION AND RELATED ART STATEMENT

The present invention relates to a system for notifying a user of a contents URL (Uniform Resource Locator) through a television set (a contents URL notification system).

In these years, with the growth of an internet user population, a large volume of contents have been provided to users from content providers via electronic communication networks. In order for the users to use the contents, the users have to access to the contents provided by the providers using the electronic communication networks. In order to access to the contents, the users have to know an URL (Uniform Resource Locator) of the contents in advance.

Conventionally, there have been various methods to notify the users of the contents URLs. Among them, especially in these years, there has been devised a system to notify the users of the contents URLs via television (TV) sets.

As such a system of notifying the contents URL via the TV set, there has been a system, which converts the contents URL to an image expressed with a matrix-type two-dimensional code, and displays the image as a TV image on a TV set monitor of the user by broadcasting the image through a broadcaster. Accordingly, the user takes a picture of the TV image thus displayed using a cellular phone, so that the user can access to the contents URL converted to the TV image using software stored in the cellular phone via the electronic communication network (refer to Patent Reference).

Patent Reference: Japanese Patent Publication No. 2006-246056

In the conventional contents URL notification system through the TV sets described above, it is possible to effectively notify the contents URL to a large number of users who watch TV programs all at once using the mass media such as the TV broadcast. However, there have been demands for further improvement from the view point of the content providers, broadcasters, and users, respectively.

From the view point of the content providers, after the providers provide (upload) the contents that they prepared in the form that the users can access via electronic communication networks, the providers request the broadcaster to broadcast the contents URL, and thereafter the broadcaster prepares TV data to broadcast. Accordingly, it takes lots of labor and a long period of time from providing the contents till the broadcasting.

On the other hand, from the view point of the broadcasters, the broadcasters simply broadcast the contents URLs. Accordingly, the broadcasters not confirm notification feedbacks such as types of viewers that use the URLs thus broadcasted, so that it is difficult to evaluate a correlation between the broadcast and TV programs of TV commercials.

Furthermore, from the view point of the users, the users are notified of the URLs through the TV broadcasts regardless of their preferences. Accordingly, they cannot see a status of usage by other users, and can simply recognize the TV broadcasts as unidirectional media, so that it is difficult to use the TV broadcasts bi-directionally.

In view of the problems describe above, an object of the present invention is to provide a contents URL notification system capable of solving the problems of the conventional contents URL notification system.

Further objects and advantages of the present invention will be apparent from the following description of the present invention.

### SUMMARY OF THE PRESENT INVENTION

In order to attain the objects described above, according to a first aspect of the present invention, a contents URL notification system is configured to notify users of contents URLs using TV sets. In the contents URL notification system, a server computer of a content provider transmits information related to the contents URL (URL information) to a client computer via an electronic communication network. The client computer prepares TV data for broadcasting the URL information received from the server computer. A terminal device of the user accesses the server computer via the electronic communication network according to the URL information extracted from the TV data thus prepared with the client computer.

According to a second aspect of the present invention, the contents URL notification system in the first aspect may include a plurality of the server computers and a plurality of the terminal devices. The client computer is configured to prepare the TV data to broadcast a plurality of different contents URLs at the same time. Further, the terminal device of the user is configured to select one of the server computers according to a plurality of the URL information extracted from the TV data.

According to a third aspect of the present invention, in the contents URL notification system in the first aspect or the second aspect, a TV set is configured to receive the broadcast and extract the URL information from the TV data. Further, the TV set is configured to transmit the URL information to the terminal device of the user.

According to a fourth aspect of the present invention, in the contents URL notification system in the first aspect to the third aspect, the server computer is configured to collect information related to the user when the terminal device of the user accesses to the server computer. Further, the server computer is configured to provide a result as new contents (collected contents) in a form that the user can access via the electronic communication network. Further, the server computer is configured to transmit the URL information of the collected contents to the client computer.

According to the present invention, in addition to providing the contents, the content provider transmits the information related to the contents URL to the broadcaster. Accordingly, it is possible to reduce lots of labor and a period of time from providing the contents till broadcasting the contents URL.

According to the present invention, when there are a plurality of the sever computers and a plurality of the terminal devices, the client computer prepares the TV data for broadcasting a plurality of the URL information of the different contents at once, and the terminal device is configured to select and access to one of the server computers according to a plurality of the URL information extracted from the TV data. Accordingly, it is possible to freely select the contents according to preference of the users who watch a TV together. Further, it is possible to easily and smoothly provide the contents URL suitable for each individual through the broadcast provided to public such as families.

According to the present invention, the contents URL notification system is configured such that the TV that receives the broadcast is configured to extract the URL information from the TV data and transmits the URL information to the terminal device. Accordingly, it is possible to provide the contents URL with reduced operating burden on the user.

According to the present invention, the result of collecting the information regarding the users is provided as the collected content and the URL information is notified to the broadcasters and the users. Accordingly, the broadcasters can see the effect of notifying the contents URL and understand a correlation with the TV program, TV commercials, etc. Further, the users can know the status of usage of the contents by other users, so that it is possible to bi-directionally use the TV broadcast.

### BRIEF DESCRIPTION OF THE DRAWINGS

FIG. 1 is a schematic view showing a configuration of a contents URL notification system according to a first embodiment of the present invention;

FIG. 2 is a time chart showing an operation of the contents URL notification system according to the first embodiment of the present invention;

FIG. 3 is a schematic view showing a configuration of a contents URL notification system according to a second embodiment of the present invention; and

FIG. 4 is a time chart showing an operation of the contents URL notification system according to the second embodiment of the present invention.

### DETAILED DESCRIPTION OF PREFERRED EMBODIMENTS

Hereunder, referring to the accompanying drawings, detailed configuration of a contents URL notification system of the present invention will be described.

The contents URL notification system of the present invention is for notifying users of a contents URL that is provided by a content provider through a TV broadcast provided by a broadcaster. With the contents URL notification system, a large number of users who watch TV broadcasts can use the content by accessing the URL that they are notified of, and it is possible to significantly increase the frequency of using the content.

### First Embodiment

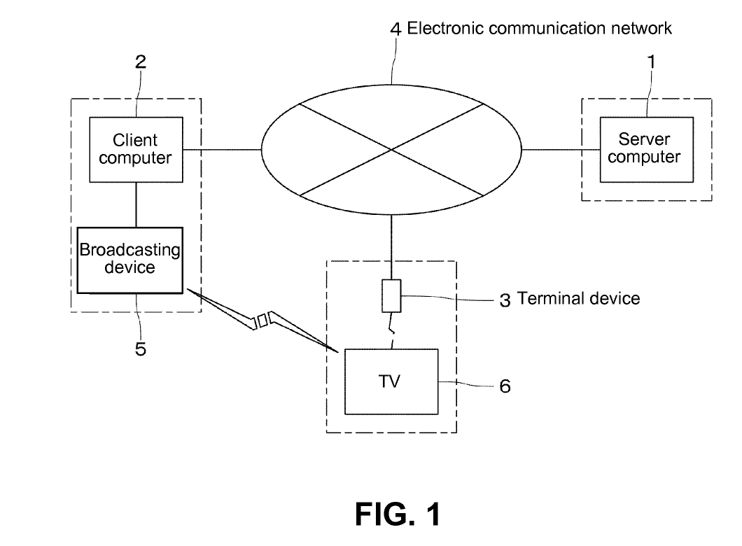

A first embodiment of the present invention will be explained. FIG. 1 is a schematic view showing a configuration of a contents URL notification system according to the first embodiment of the present invention. As shown in FIG. 1, according to the first embodiment, a server computer 1 of a content provider, a client computer 2 of a client of a broadcaster, and a terminal device 3 of a user are connected so as to be communicable via an electronic communication network 4.

The client computer 2 is connected to a broadcasting device 5, which is composed of devices required for TV broadcasts, so as to be able to transmit data.

The terminal device 3 of the user is connected to a TV set (a TV 6) that is composed of devices required to receive TV broadcasts and display TV data so as to be able to receive data.

The electronic communication network 4 that connects the server computer 1, the client computer 2, and the terminal device 3 can be any as long as the server computer 1 and the client computer 2 and the server computer 1 and the terminal device 3 can communicate each other. Such electronic communication network 4 can be a public line such as internet or an exclusive line such as intranet, and it includes the one that is configured to connect the server computer 1 and the client computer 2 with an exclusive line and connect the server computer 1 and the terminal device 3 with a public line.

The client computer 2 and the broadcasting device 5 can be connected in any way as long as it is possible to transmit data in the client computer 2 to the broadcasting device 5, and do not have to be connected via an exclusive line, but may be connected using the electronic communication network 4, and also includes the one that is configured to be able to transmit data by manual operation via a recording medium.

The terminal device 3 can be an integrated type such as a cellular phone machine or PDA (Personal Digital Assistant: mobile information terminal), and may be a set that is composed of a computer and peripherals. However, the terminal device 3 has to be able to receive data from the TV 6 as well as communicating with the server computer 1, and may be the one that is configured to be able to receive data from the TV 6 by taking an image TV image displayed on a monitor of the TV 6 and analyzing it as is practically applied in matrix-type two-dimensional code, or may be the one that is configured to be able to communicate using an exclusive line or perform wireless communication. Moreover, the terminal device 3 can include a built-in tuner that can receive TV broadcasts and software that can analyze analogue or digital TV signals that are received.

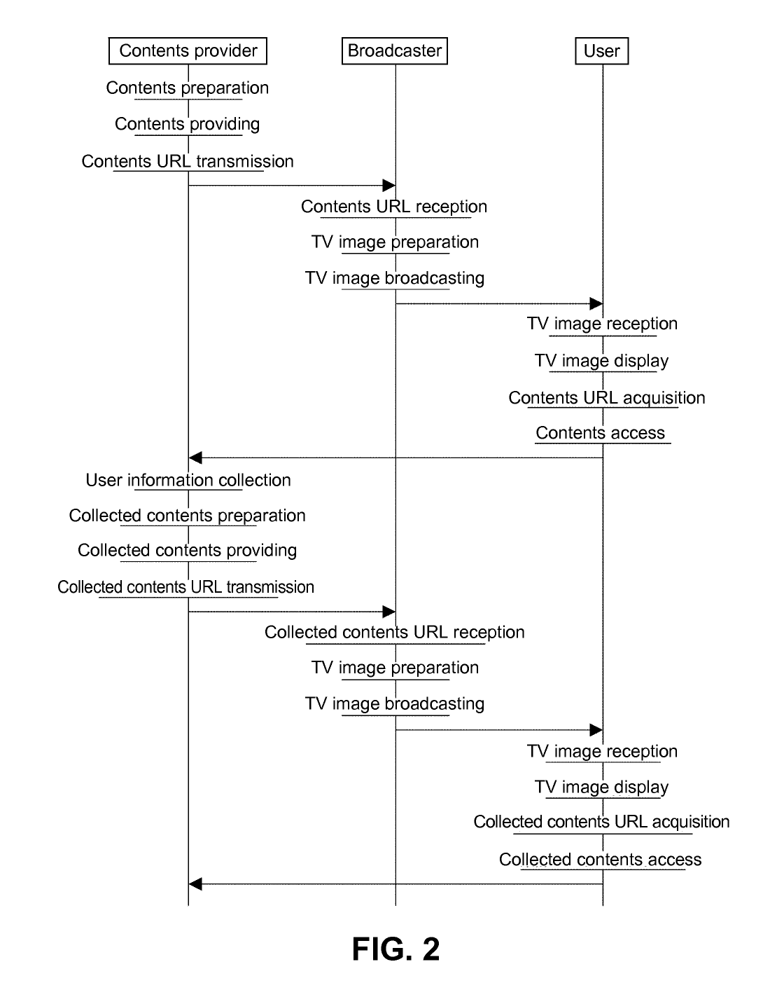

Then, according to the system, using the hardware configuration shown in FIG. 1, the content provider, the broadcaster, and the user can mutually collaborate as shown in FIG. 2 to notify a user of a contents URL provided by content provider through a TV broadcast by the broadcaster. FIG. 2 is a time chart showing an operation of the contents URL notification system according to the first embodiment of the present invention.

More specifically, as shown in FIG. 2, first the content provider prepares a content that can be used by the server computer 1 via the electronic communication network 4 (content preparation step). Here, in this content preparation step, the content provider may prepare the content by itself, but the content provider may request a content preparer to prepare a content, and a content may be prepared by providing a program to prepare contents (CMS: content management System) via the electronic communication network 4.

Then, the content provider provides the content prepared in the content preparation step in the form that can be used by the server computer 1 via the electronic communication network 4. In order to provide the content in the usable form, the content has to be provided so that the user can access the content via the electronic communication network 4. For this purpose, the URL, a location of the content on the electronic communication network, is to be determined for respective contents.

Next, the content provider transmits information regarding

URL (URL information) determined for the content to provide in the content providing step from the server computer 1 to the client computer 2 via the electronic communication network 4 (contents URL transmitting step). Here, the URL information can be any as long as it is information containing contents URL, and can contains only a character string that simply indicates URL, or an image made by converting the URL to a matrix-type two-dimensional code, or can be information that includes URL and additionally contains name of the provider, summary of the content, etc.

Corresponding to the contents URL transmitting step, the broadcaster receives URL information transmitted from the server computer 1 via the electronic communication network 4 by the client computer 2 (contents URL receiving step).

Thereafter, the broadcaster prepares TV data containing the contents URL using the client computer 2 based on the URL information received in the contents URL receiving step (TV data preparing step). Here, the TV data containing a contents URL can be also an image that displays a character string that indicates URL, and also an image that displays information that includes name of the provider, summary of the contents, etc. in addition to the URL. Furthermore, the TV data can be digital signals as well as analog signals, and can be described in special language such as data broadcasting description language such as BML (Broadcast Markup Language).

Next, the broadcaster converts the TV data prepared in the TV data preparing step to analogue or digital TV signals, and broadcasts on TVs as a TV program, TV commercial, or the like using the broadcasting device 5 (TV broadcasts step). Here, TV broadcasts are not limited to the one by typical analogue or digital TV broadcasts, but can be the one by data broadcasting used in digital TV broadcasts.

Corresponding to this TV broadcasting step, the user who is also a viewer of TV broadcasts, receives TV signals broadcasted from the broadcasting device 5 of the broadcaster using the TV 6 (TV signal receiving step), and thereby the TV signals are displayed as an image on a monitor by the TV 6 (TV image displaying step).

Thereafter, the user obtains contents URL contained in the TV data from the TV image displayed on the TV 6 in the TV image displaying step using the terminal device 3 (contents URL obtaining step).

Here, in the contents URL obtaining step, for example, the contents URL may be extracted by taking an image and analyzing the contents URL displayed on a monitor of the TV 6 in a matrix-type two-dimensional code using the terminal device 3.

Furthermore, as the contents URL obtaining step, it is possible to configure such that the user directly obtains the contents URL by analyzing TV signals received using built-in hardware and software in TV 6, extracting the contents URL, and then transmitting the URL from the TV 6 to the terminal device 3 using a communication function by an exclusive line or wireless communication function.

Moreover, the contents URL obtaining step may be configured so as to extract a part of special language received using built-in hardware and software in the TV 6, transmit it as is or after converting to data in a specific format using a communication function using an exclusive line or wireless function from the TV 6 to the terminal device 3 so as to extract the contents URL.

In this case, special data may be added to the data that indicate regular broadcasting contents described in special language such as BML using TV signals to be broadcasted on TV, then transmitted from the broadcasting device 5 to the TV 6, data indicating broadcasting contents and special data are separated using built-in hardware and software of TV 6 in advance, special data are transmitted from the TV 6 to the terminal device 4, and the contents URL is extracted from the special data using hardware and software that are build in the terminal device 3 in advance.

Next, the user accesses the server computer 1 from the terminal device 3 via the electronic communication network 4 using the URL obtained in the contents URL obtaining step (content accessing step). With this procedure, the user can use the contents. Here, details of the contents may not be specifically limited, but preferably the one that is related to the TV program or TV commercial that is broadcasted at the same time, and for example suitably questionnaires, sales, or free sample offers of a product that is broadcasted at the same time as TV program or TV commercial.

When there is an access from a user according to the content accessing step, a content provider can collect information about users, using the server computer 1 (user information collecting step). In this user information collecting step, such information may include, for example, total number of users, itemized numbers of the users by genders and age groups, questionnaire results, sales, and free sample offer results.

Accordingly, the content provider can prepare a new content (collected content) from the result obtained by executing the user information collecting step using the server computer 1 (collected content preparing step), and can provide (upload) the collected content prepared in the post information collection preparing step by the server computer 1 via the electronic communication network 4 (collected contents providing step). For this collected content, corresponding URL is determined similarly to the aforementioned content.

Thereafter, the content provider transmits from the server computer 1 to the client computer 2 via the electronic communication network 4 the information about URL (URL information) that is determined corresponding to the collected content to provide in the collected content providing step (collected contents URL transmitting step).

Corresponding to the collected contents URL transmitting step, the broadcaster receives the URL information of the collected content that is transmitted by the client computer 2 from the server computer 1 via the electronic communication network 4 (collected contents URL receiving step).

Then, the broadcaster prepares TV data for TV broadcasting that includes the URL of the collected content using the client computer 2 based on the URL information received in the collected contents URL receiving step (TV data preparing step). The prepared TV data are broadcasted on TVs as a TV program or TV commercial using the broadcasting device 5 (TV broadcasting step). Corresponding to this step, a user receives TV signals broadcasted from the broadcasting device 5 of the broadcaster using the TV 6 (TV receiving step), and a TV image is displayed on a monitor by the TV (TV image displaying step).

As such, the user can extract the URL of the collected content using the terminal device 3 from the TV data displayed on TV 6 in the TV data displaying step (collected contents URL obtaining step). In addition, using the URL extracted in the collected contents URL obtaining step, the user can access the server computer 1 from the terminal device 3 via the electronic communication network 4 (collected content accessing step).

As described above, according to this system, the system that notifies a contents URL through TV data, the server computer 1 of the content provider executes a content providing step to provide a content via the electronic communication network 4 and executes a contents URL transmitting step to transmit the URL information of the content to the client computer 2 of the broadcaster.

Therefore, according to the system, the content provider provides content and also transmits information of contents URL to provide to the broadcaster, so that it is possible to reduce labor and time required from providing content till broadcasting.

Moreover, when the TV 6 that receives TV broadcasts extracts URL information from the TV data and transmits to the terminal device 3 of the user, it is possible to provide a URL with reduced burden for the user upon operation.

In addition, according to the system, when the server computer 1 of the content provider has its content accessed from the terminal device 3 of the user, the system executes the use information collecting step to collect information about users, then executes the collected content providing step to provide the result obtained from execution of the user information collecting step as a new content (collected content) in the form accessible by users via the electronic communication network 4, and also executes the collected contents URL transmitting step to transmit the URL information of the collected content to the client computer 2 of the broadcaster.

Therefore, according to this system, the result of collecting information about users is provided as collected content, and also the URL information is notified to the broadcaster and the users, so that the broadcaster can recognize the effect of notifying the contents URL and understand correlation to the TV program or TV commercial, whereas the user can know the status of use by other users; therefore it is possible to use TV broadcasts bi-directionally.

### Second Embodiment

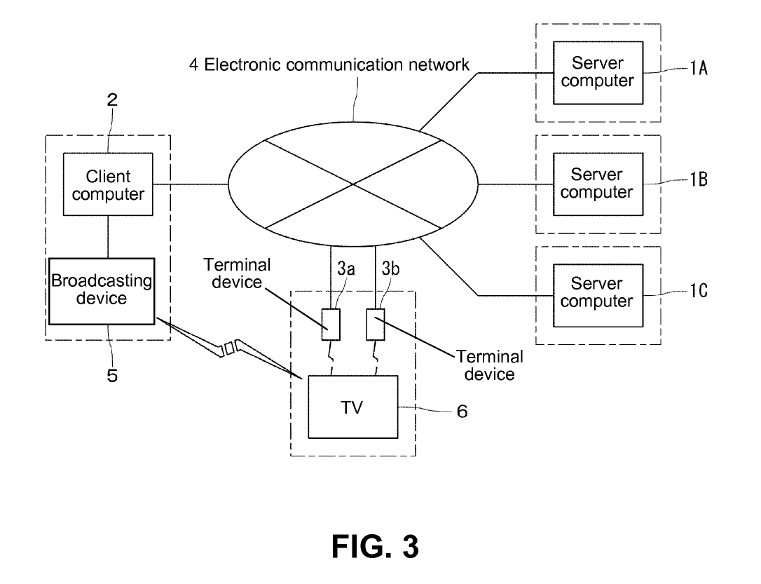

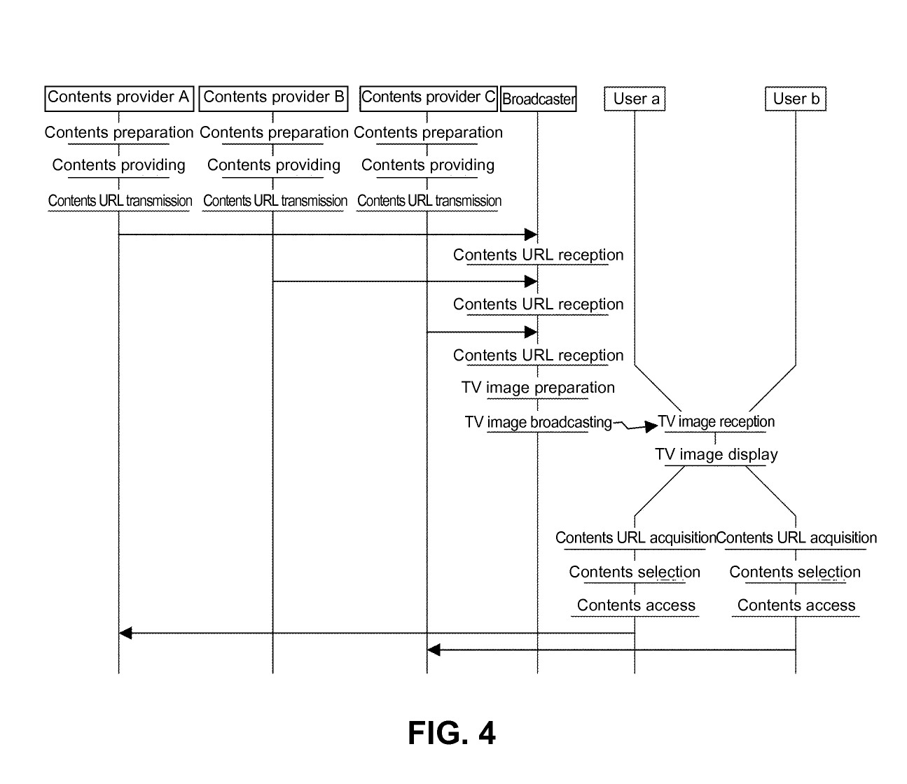

A second embodiment of the present invention will be explained next. FIG. 3 is a schematic view showing a configuration of a contents URL notification system according to the second embodiment of the present invention. FIG. 4 is a time chart showing an operation of the contents URL notification system according to the second embodiment of the present invention.

As shown in FIG. 3, according to the system of Second embodiment, using the hardware configuration shown in FIG. 3, the content providers A, B, and C, broadcaster, and users a and b mutually collaborate as shown in FIG. 4 so as to notify the users a and b of contents URLs provided by the content providers A, B, and C through TV broadcasts provided y the broadcaster.

More specifically, as shown in FIG. 4, first the content providers A, B, and C respectively prepare contents that are usable via the electronic communication network 4 by the server computers 1A, 1B, and 1C (content preparing step). Thereafter, information of URL (URL information) determined corresponding to each content is transmitted to the client computer 2 via the electronic communication network 4 from the server computers 1A, 1B, and 1C (contents URL transmitting step).

Corresponding to the contents URL transmitting step, the broadcaster receives URL information transmitted by the client computer 2 from the respective server computers 1A, 1B, and 1C via the electronic communication network 4 (contents URL transmitting step).

Then, the broadcaster prepares TV data that contains URLs of all contents using the client computer 2 based on the all URL information received in the contents URL receiving step (TV data preparing step).

Next, the broadcaster converts the TV data prepared in the

TV data preparation step to analogue or digital TV signals, and broadcast on TV as a TV program or TV commercial using the broadcasting device 5 (TV broadcasting step).

Corresponding to the TV broadcasts, the users a and b, which are also TV viewers, receive TV signals broadcasted from the broadcasting device 5 of the broadcaster using one TV 6 (TV signal receiving step), and thereby the TV signals are displayed as an image on a monitor by the TV 6 (TV image displaying step). Thereafter, the users obtain a plurality of contents URLs contained in the TV data using the terminal device 3 from the TV image displayed on the TV 6 in the TV image displaying step (contents URL obtaining step).

Here, as the contents URL obtaining step, for example, it may be configured to extract respective contents URLs by taking an image of and analyzing a plurality of contents URLs displayed on a monitor of the TV 6 as a sheet of image in a matrix-type two-dimensional code using the terminal device 3. In addition, the contents URL obtaining step may be configured to analyze TV signals received using built-in hardware and software of the TV 6 to extract a plurality of contents URLs and then transmit the all URLs from the TV 6 to the terminal device 3 using a communication function by an exclusive line or wireless communication function.

Moreover, the contents URL obtaining step may be configured to extract a part of special language received using built-in hardware and software of the TV 6, transmit as is or after converting to data in specific format from the TV 6 to the terminal device 3 using a communication function with an exclusive line or wireless communication function, and analyze data received by the terminal device 3 to extract a plurality of contents URLs.

Next, a user selects one URL from all the URLs obtained in the contents URL obtaining step and access to the server computer 1 from the terminal device 3 via the electronic communication network 4 (content accessing step). With this operation, the user can use the selected content.

As described above, there are provided a plurality of server computers 1A, 1B, and 1C and a plurality of terminal devices 3a and 3b and the client computer 2 prepares TV data to broadcast on TV at once a plurality of URL information with various contents. In addition, when one of the server computers 1A, 1B, and 1C is selected to access based on a plurality of URL information extracted from the TV data by the terminal devices 1a and 1b, each user a or b can freely select content according to preference of the users a and b who watches the TV 6 together, so that it is possible to easily and smoothly provide contents URLs in accordance with each individual's preference through TV broadcasts that is provided to the public such as families.

While the invention has been explained with reference to the specific embodiments of the invention, the explanation is illustrative and the invention is limited only by the appended claims.

What is claimed is:

1. A contents URL notification system for notifying a contents URL to a user, comprising,
a server computer for transmitting information related to the contents URL (URL information) via an electronic communication network;
a client computer for receiving the URL information from the server computer and preparing television data for broadcasting the URL information; and
a terminal device for accessing the server computer via the electronic communication network according to the URL information extracted from the television data prepared with the client computer.

2. The contents URL notification system according to claim 1, wherein said server computer and said terminal device are situated at a plurality of locations, said client computer being configured to prepare the television data to broadcast a plurality of different contents URLs at the same time, said terminal devices being configured to select one of the server computers according to the URL information extracted from the television data.

3. the contents URL notification system according to claim 1, further comprising a television set for receiving the television data and extracting the URL information from the television data, said television set being configured to transmit the URL information to the terminal device.

4. The contents URL notification system according to claim 1, wherein said server computer is configured to collect information related to the user when the terminal device accesses to the server computer, said server computer being configured to provide a result as new contents (collected contents) in a form that the user can access via the electronic communication network, said server computer being configured to transmit the URL information of the collected contents to the client computer.

5. A method of notifying a contents URL to a user, comprising the steps of:
transmitting information related to the contents URL (URL information) from a server computer via an electronic communication network;
receiving the URL information from the server computer and preparing television data with a client computer for broadcasting the URL information; and
accessing the server computer with a terminal device via the electronic communication network according to the URL information extracted from the television data prepared with the client computer.
